(19) United States
(12) Patent Application Publication
(10) Pub. No.: US 2018/0010680 A1
(43) Pub. Date: Jan. 11, 2018

(54) ROTARY SEALING ARRANGEMENT

(71) Applicant: Goodrich Actuation Systems Limited, Shirley (GB)

(72) Inventor: Stephen DAVIES, Shrewsbury (GB)

(21) Appl. No.: 15/643,776

(22) Filed: Jul. 7, 2017

(30) Foreign Application Priority Data
Jul. 8, 2016 (EP) 16275097.0

(51) Int. Cl. F16H 57/029

(52) U.S. Cl. CPC F16H 57/029; F16J 15/3232; F16J 15/3268

(57) ABSTRACT

A rotary sealing arrangement comprises a housing, a shaft mounted for rotation within the housing about a shaft axis (A) and a rotary seal provided between the housing and the shaft. The rotary seal comprises a static seal element mounted to the housing and a rotary sealing element mounted for rotation with the shaft. The static seal element comprises a mounting part and a flexible lip seal extending from the mounting part in an axial direction relative to the shaft. The rotary seal element comprises a seal body comprising an axially facing sealing face. The lip seal resiliently engages the sealing face of the seal body. The static seal element and the rotary seal element are mounted such that the relative axial positions of the static seal element and the rotary seal element can be adjusted.

### FOREIGN PRIORITY

This application claims priority to European Patent Application No. 16275097.0 filed Jul. 8, 2016, the entire contents of which is incorporated herein by reference.

### TECHNICAL FIELD

The present disclosure relates to rotary sealing arrangements, in particular rotary sealing arrangement between a rotating shaft and a static housing for example in a gearbox.

### BACKGROUND

A wide variety of rotary sealing arrangements are known. In a known arrangement, a radial seal is mounted in a housing surrounding a shaft. The radial seal comprises a radially projecting sealing lip which makes sealing engagement with an opposed sealing surface of the shaft to reduce lubricant loss from the housing and ingress of environmental materials, for example dirt or fluids, into the housing. Whilst such systems operate quite satisfactorily, they may have certain potential drawbacks.

Firstly, the portion of the shaft which engages with the lip may need to be made from a relatively hard material (for example having a hardness of 55Rc or higher to ensure a viable life for the seal. This may complicate the shaft construction and cost as it may have to be plated or plasma sprayed in the sealing region. Moreover, the sealing region of the shaft needs to be produced to high tolerances, thereby adding to complexity and cost.

Secondly, there is no possibility of adjusting the seal. The shaft portion is of a fixed diameter and the radial position of the lip cannot be adjusted. This means provides little flexibility in adapting a seal to different installations.

### SUMMARY

The present disclosure provides a rotary sealing arrangement which comprises a housing, a shaft mounted for rotation within the housing about a shaft axis and a rotary seal provided between the housing and the shaft. The rotary seal comprises a static seal element mounted to the housing and a rotary sealing element mounted for rotation with the shaft. The static seal element comprises a mounting part and a flexible lip seal extending from the mounting part in an axial direction relative to the shaft. The rotary seal element comprises a seal body comprising an axially facing sealing face. The lip seal resiliently engages the sealing face of the seal body. The static seal element and the rotary seal element are mounted such that the relative axial positions of the static seal element and the rotary seal element can be adjusted.

In certain embodiments, the mounting part may be movable relative to the housing.

For example, the mounting part of the static sealing element may comprise an externally threaded portion which is threadably received in a threaded bore of the housing to permit adjustment of the axial position of the static sealing element within the housing.

The lip seal may be mounted to and project axially from a radially inwardly extending flange of the mounting part.

The flexible lip seal may comprise a plurality of sealing lips.

The rotary seal element may comprise an annular body mounted on the shaft.

The rotary seal element may be mounted on said shaft in an axially adjustable manner.

In embodiments of the disclosure, an abutment face of the rotary seal element opposite the sealing face may axially abut a rotary abutment surface of or coupled to the shaft.

The abutment face may abut a bearing race mounted to the shaft.

The disclosure also extends to a gearbox comprising an input shaft, an output shaft and a sealing arrangement as disclosed above provided between a housing of the gearbox and one or both of the input and output shafts.

The disclosure also extends to a method of setting the drag of a sealing arrangement as disclosed above comprising adjusting the relative axial positions of the rotary sealing element and the static sealing element.

In certain embodiments, the method may comprise removing material from the abutment face of the rotary sealing element to adjust the axial thickness of the sealing element body and thereby adjust the distance between the sealing surface of the rotary sealing element and the rotary abutment.

In certain embodiments, the method may comprise placing shims between the abutment face of the rotary sealing element and the rotary abutment to adjust the axial distance between the sealing surface of the rotary sealing element and the rotary abutment.

In certain embodiments, the method may comprise moving the static seal element relative to the housing.

For example, the method may comprise screwing the static sealing element into or out of the housing bore to effect the movement.

### BRIEF DESCRIPTION OF DRAWINGS

An embodiment of this disclosure will now be described, by way of example only, with reference to the accompanying drawings in which:

FIG. 1 illustrates a gear box incorporating a sealing arrangement in accordance with the disclosure.

FIG. 2 shows a detail of the sealing arrangement;

FIG. 3 illustrates a first method of adjusting the drag of the sealing arrangement of FIGS. 1 and 2; and

FIG. 4 illustrates a second method of adjusting the drag of the sealing arrangement of FIGS. 1 and 2.

### DETAILED DESCRIPTION

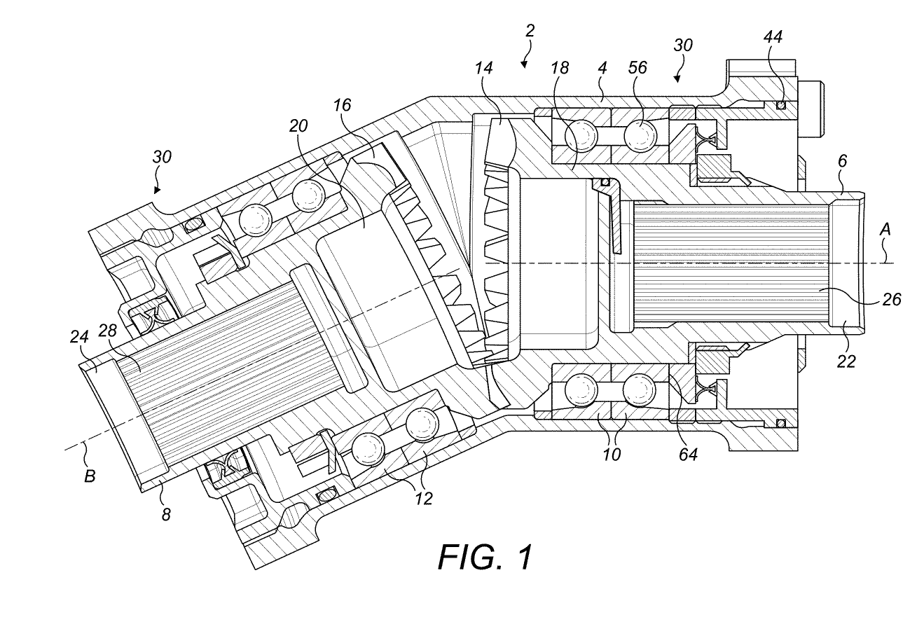

FIG. 1 illustrates a gearbox 2 as might be used, for example, in a high lift actuation system for an aircraft wing. A high lift actuation system may comprise a number of gearboxes, in some cases up to 40 gearboxes, on a large aircraft.

In this embodiment, the gearbox 2 comprises a gearbox housing 4, a rotary input shaft 6 and a rotary output shaft 8. While one shaft has been designated an input shaft 6 and the other shaft an output shaft 8, it will be appreciated that either shaft may act as the input or output shafts. The input shaft 6 is rotationally supported in the housing 4 for rotation about a first axis A by a first pair of bearings 10. The output shaft 8 is rotationally supported in the housing 4 for rotation about a second axis B by a second pair of bearings 12. In this example, the bearings 10, 12 are ball bearings but other bearings may be employed in certain embodiments.

It will be seen that in this embodiment the first and second axes A, B are at an angle to one another. In order to transmit drive from the input shaft 6 to the output shaft 8, opposed, intermeshing axially facing gears 14, 16 are provided on the opposed proximal ends 18, 20 of the input shaft 6 and output shaft 8. The distal ends 22, 24 of the input shaft and output shaft 8 are provided with internal splines 26, 28 for coupling to respective draft shafts (not shown). Of course other forms of coupling could be provided.

The gearbox housing 4 will be filled with suitable lubricants, for example oil or grease and to prevent egress of lubricant from the housing 4, or ingress of environmental contaminants such as water or particulates into the housing 4, a rotary seal 30 is provided between the housing 4 and each of the input and output shafts 6, 8.

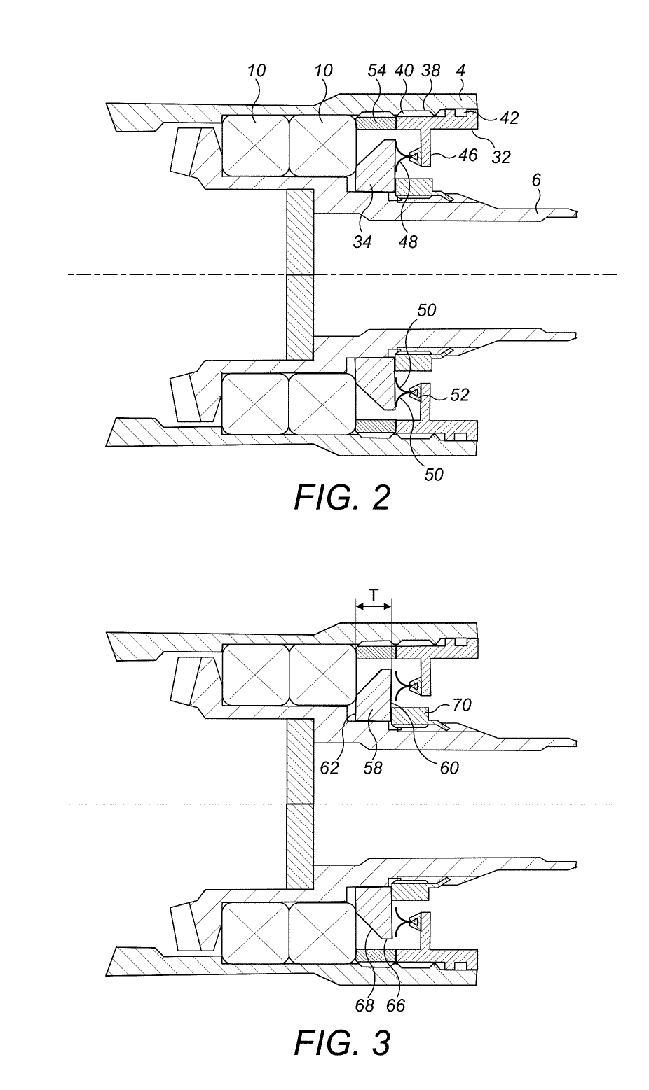

The rotary seal 30 on the input shaft 6 and in accordance with this disclosure is illustrated in greater detail in FIGS. 2 to 4. The rotary seal on the output shaft 8 of the gearbox FIG. 1 is illustrated as a radial lip seal, but it will be appreciated that in accordance with this disclosure, it may alternatively or additionally be constructed as per the rotary seal 30 on the input shaft.

The rotary seal 30 provided at the input shaft 6 comprises a static seal element 32 which is mounted to the gearbox housing 4 and a rotary seal element 34 mounted to the input shaft 6.

The static seal element 32 comprises a mounting part 36 with an externally threaded outer surface portion 38 which is threadably received in an internally threaded bore 40 of the gearbox housing 4. A groove 42 is formed in one end of the external surface portion 38 to receive an O-ring 44 (FIG. 1).

The mounting part 36 further comprises a radially inwardly extending flange 46. Mounted to the flange 46 is an axially facing lip seal 48. In this embodiment, the lip seal 48 is bifurcated, comprising two axially extending lips 50. The lip seal 48 may be made as a single component as illustrated or as an assembly. In addition, the lip seal 48 may comprise just a single lip 50 or multiple lips 50. The lip seal 48 may be mounted to the flange by a mount ring 52.

As illustrated, a threaded ring 54 is arranged between the static sealing element 32 and the outer race 56 (FIG. 1) of the axially outermost bearing 4 to retain the outer race 56 in the housing.

The rotary seal element 34 is formed as an annular body mounted on, and for rotation with, the input shaft 6.

The rotary seal element 34 comprises a seal runner body 58 comprising an axially facing sealing face 60 and an opposed abutment face 62. The sealing face 60 opposes the lip seal 48 of the static seal element 32, the lip seal resiliently engaging the sealing face 60 in use. The abutment surface 62 engages the inner race 64 of the axially outermost bearing 4. The abutment surface 62 is connected to a radially outermost surface 68 of the rotary seal element 34 by an angled surface 68. This reduces the weight of the rotary seal element 34 and also avoids interference with the outer race 56 of the bearing 4.

The seal runner body 58 is retained axially against the inner race 64 of the bearing 4 by a fastener, for example a threaded clamping ring 70 which is threadably received on the input shaft 6.

The seal runner body 58 is made from a suitably hard material, for example having a hardness of 55Rc or higher. A suitable material may be, for example a stainless steel such as AISI 440C.

An advantage of the embodiment described above over the traditional radial sealing is that the sealing surface 60 may be provided on a relatively small body 58 which may be purpose built for sealing rather than sealing being effected with a surface portion of the shaft 6 which would have to be specially treated for that purpose, adding to the complexity and cost of the shaft 6.

A further advantage of the embodiment described above is that it allows the drag of the seal 30 to be adjusted both during original manufacture and thereafter.

FIG. 3 illustrates such an adjustment during the initial build of the seal 30. In this embodiment, the axial thickness T of the seal runner body 58 can be varied to position the sealing face 60 thereof in the appropriate axial position to provide an appropriate drag. To achieve this, the abutment face may be machined, for example ground, to produce the appropriate thickness T. The static seal element 32 may then be inserted to a predetermined depth in the gearbox housing 4 to provide the appropriate axial spacing between the sealing face 60 of the seal runner body 50 and the static seal element 32.

Alternatively (or additionally), to adjust the axial spacing, the seal runner body 58 may be fixed on the shaft 6 and the static seal element 32 mounted to the gearbox housing 4. The mounting part 36 thereof may be adjusted to the appropriate depth in the housing bore 40 via the threaded interface therebetween and secured in position by locking the thread in position using any conventional means, for example adhesive, thread deformation or a self-locking pad or washer.

This arrangement is advantageous in that it reduces the tolerances required of the individual seal components as compared with the traditional radial seal arrangement.

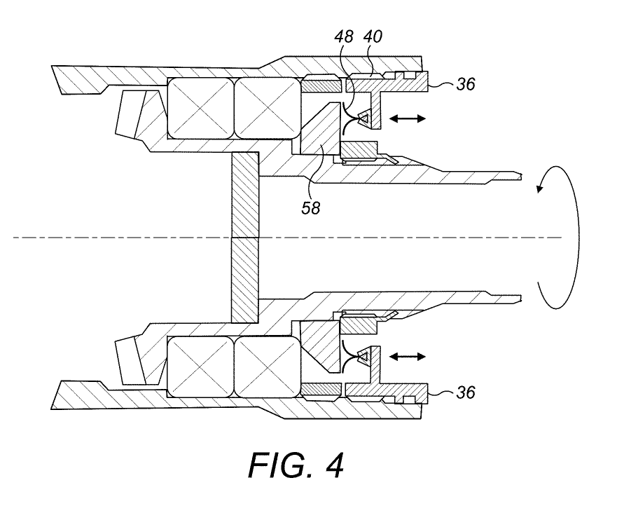

The drag of the seal 30 may vary over time, for example as the seal wears. The embodiment described above also allows this to be accounted for. As illustrated schematically in FIG. 4, the squeeze on the lip seal 48 can be varied by screwing the mounting part 36 of the static seal element 32 into or out of the housing bore 40. To increase the drag (as would be required when the seal has worn) the mounting part 36 would be screwed further into the bore 40.

In other circumstances, for example during testing of the seal, it may be desirable to reduce the drag. This can be achieved by screwing the mounting part 36 further out of the housing bore 40.

Thus it will be appreciated that the embodiments of the disclosure described herein may have significant advantages over the prior radial seal arrangements in terms of cost and adjustability.

It will be further appreciated that modifications may be made to the particular embodiments disclosed without departing from the scope of the disclosure. For example, while the mounting part 36 is disclosed as being externally threaded, it may be threadedly engaged with the housing 4 in any suitable manner.

1. A rotary sealing arrangement comprising:
a housing;
a shaft mounted for rotation within the housing about a shaft axis (A);
a rotary seal provided between the housing and the shaft;
the rotary seal comprising a static seal element mounted to the housing and comprising a mounting part and a flexible lip seal extending from the mounting part in an axial direction relative to the shaft;
a rotary seal element comprising a seal body comprising an axially facing sealing face and mounted for rotation with the shaft, the lip seal resiliently engaging the sealing face of the seal body;
the static seal element and the rotary seal element being mounted such that the relative axial positions of the static seal element and the rotary seal element can be adjusted.

2. A sealing arrangement as claimed in claim 1, wherein the mounting part is movable relative to the housing.

3. A sealing arrangement as claimed in claim 2, wherein the mounting part of the static sealing element comprises an externally threaded portion which is threadably received in a threaded bore in the housing to permit adjustment of the axial position of the static sealing element within the housing.

4. A sealing arrangement as claimed in claim 1, wherein the lip seal is mounted to and projects axially from a radially inwardly extending flange of the mounting part.

5. A sealing arrangement as claimed in claim 1, wherein the flexible lip seal comprises a plurality of sealing lips.

6. A sealing arrangement as claimed claim 1, wherein the rotary seal element comprises an annular body mounted on the shaft.

7. A sealing arrangement as claimed in claim 5, wherein said rotary seal element is mounted on said shaft in an axially adjustable manner.

8. A sealing arrangement as claimed claim 1, wherein an abutment face of the rotary seal element opposite the sealing face axially abuts a rotary abutment surface of or coupled to the shaft.

9. A sealing arrangement as claimed in claim 1, wherein the abutment face abuts a bearing race mounted to the shaft.

10. A gearbox comprising:
an input shaft;
an output shaft;
a housing, wherein the input shaft is mounted for rotation within the housing about a shaft axis (A);
a sealing arrangement, the sealing arrangement including:
a rotary seal provided between the housing and the input shaft;
the rotary seal comprising a static seal element mounted to the housing and comprising a mounting part and a flexible lip seal extending from the mounting part in an axial direction relative to the shaft; and
a rotary seal element comprising a seal body comprising an axially facing sealing face and mounted for rotation with the shaft, the lip seal resiliently engaging the sealing face of the seal body;
wherein the static seal element and the rotary seal element are mounted such that the relative axial positions of the static seal element and the rotary seal element can be adjusted, and
wherein the sealing arrangement is between the housing of the gearbox and one or both of the input and output shafts.

11. A method of setting the drag of a sealing arrangement as claimed in claim 10 comprising: adjusting the relative axial positions of the rotary sealing element and the static sealing element.

12. A method as claimed in claim 11, wherein an abutment face of the rotary seal element opposite the sealing face axially abuts a rotary abutment surface of or coupled to the shaft, the method further comprising removing material from the abutment face of the rotary sealing element to adjust the axial thickness (T) of the sealing element body and thereby adjust the distance between the sealing surface of the rotary sealing element and the rotary abutment.

13. A method as claimed in claim 11, wherein an abutment face of the rotary seal element opposite the sealing face axially abuts a rotary abutment surface of or coupled to the shaft, the method further comprising placing shims between the abutment face of the rotary sealing element and the rotary abutment to adjust the axial distance between the sealing surface of the rotary sealing element and the rotary abutment.

14. A method as claimed in claim 11, comprising moving the static seal element relative to the housing.

15. A method as claimed in claim 14, wherein the mounting part is movable relative to the housing, the method further comprising screwing the static sealing element into or out of the housing bore to effect the movement.
